(19) United States
(12) Patent Application Publication
(10) Pub. No.: US 2014/0336087 A1
(43) Pub. Date: Nov. 13, 2014

(54) DRILLING SOLUTIONS AND METHODS

(71) Applicant: Global Polishing Systems LLC, Henderson, NV (US)

(72) Inventor: Mark Wetherell, Henderson, NV (US)

(73) Assignee: Global Polishing Systems LLC, Henderson, NV (US)

(21) Appl. No.: 14/274,354

(22) Filed: May 9, 2014

Related U.S. Application Data
(60) Provisional application No. 61/821,621, filed on May 9, 2013.

(51) Int. Cl. C09K 8/03

(52) U.S. Cl. CPC C09K 8/032; C09K 2208/10
USPC 507/140

(57) ABSTRACT

A drilling fluid for discharging in a borehole to facilitate drilling operations, and hydraulic fracturing in particular, comprising amorphous silicas having a particle size ranging from about one to about ten nanometers and water, wherein the pH of the fluid is substantially neutral.

### CROSS-REFERENCE TO RELATED APPLICATIONS

This application claims the benefit of U.S. Provisional Application No. 61/821,621, filed May 9, 2013, the disclosure of which is incorporated herein by reference.

### BACKGROUND OF THE INVENTION

The invention is generally related to the field of earth boring or drilling tools, and in particular to a drilling fluid composition, and method and apparatus for directing drilling fluid of the invention to the cutting edges of various downhole tooling, such as the drilling bit cutters, which may be polycrystalline diamond cutters (PDCs).

Drilling fluid is introduced to the face of a drill bit through passageways or nozzles in a bit. The drilling fluid flows around the bit, more particularly the cutting face of the bit, thereby cooling the bit and washing the cutting elements so that they would present a clean cutting face. The drilling fluid then moves the cuttings to the gauge of the bit and there lift them up the annulus between the drill string and the wall of the borehole.

Hydrocarbons (e.g., oil and natural gas) in a hydrocarbon-bearing zone of a subterranean formation can be reached by drilling a borehole into the earth, either on land or under the sea that penetrates into the hydrocarbon-bearing formation. Since hydrocarbons, such as oil and natural gas, are often found underground in “tight” geological formations, such as sandstone or shale, their extraction requires unconventional drilling and completion techniques. These techniques include the “fracturing” (or “fracking”) of the geological strata that contain the hydrocarbons to allow those hydrocarbons to be released for recovery, treatment, storage and distribution. Existing fracturing methods are hydraulic. Hydraulic fracturing involves injecting a drilling fluid through the borehole and into an oil and gas bearing subterranean formation at a sufficiently high rate of fluid flow and at a sufficiently high pressure to initiate and extend one or more fractures in the formation.

Due to the large quantities of drilling fluid required, the fluid used in fracturing is preferably based on readily-available and plentiful fluid. Thus, the typical fluid is based on water, and more specifically, water modified or treated with chemical additives to facilitate the fracturing process.

The drilling fluid used in fracturing is injected through the borehole at such a high flow rate and under such high pressure that the rock of the subterranean formation that is subjected to the hydraulic treatment literally cracks apart or fractures under the strain. When the formation fractures, the pressure is relieved as the fluid starts to move quickly through the fracture and out into the formation. The theoretical objective of forming such a fracture in the rock of the formation is to create a large surface area of the faces of the fracture. The large surface area allows oil and gas to flow from the rock of the subterranean formation into the fracture, which provides an easy path for the oil and gas to easily flow into the well.

Once the high pressure is relieved by the escape of the drilling fluid through the created fracture and out further into the subterranean formation, the fracture has a tendency to be squeezed closed by the natural pressures on the rock within the deep subterranean formation. To keep the fracture open, some kind of material must be placed in the fracture to prop the faces of the fracture apart, hence the addition of a proppant to the drilling fluid used for fracturing.

Hydraulic fracturing methods suffer from a number of significant disadvantages. The drilling fluids that are presently used in standard hydraulic fracturing, such as for example, chemically modified or treated water at ambient temperatures, and/or cryogenic liquid nitrogen, result in waste streams of contaminated water or gaseous methane containing nitrogen. More particularly, using water or nitrogen can result in the contamination of both the drilling fluids and the hydrocarbons, and using nitrogen or liquid carbon dioxide also requires using foaming agents.

The subsequent waste drilling fluid streams need to be treated, and the cost of fully cleaning and properly disposing of the spent drilling fluid from hydraulic fracturing substantially increases the cost of hydraulic fracturing, both in economic terms and environmental terms.

Additionally, in any drilling process, the tooling, such as the drill bit, is subject to significant stresses and require replacement which adds expense for parts and results in expensive down-time. Drilling fluids can facilitate drilling or fracturing, but they do not necessarily facilitate the drilling process in a way which eases the burden on the tooling or lengthen the subsequent replacement cycle.

What is needed is a drilling fluid which can facilitate both conventional drilling and hydraulic fracturing processes, and if possible, lengthens the replacement cycle of the drill bit.

### SUMMARY OF THE INVENTION

Some embodiments of the invention are directed to a drilling fluid for discharging adjacent a drill bit during subterranean drilling in a borehole, the fluid comprising amorphous silicas having a particle size ranging from about one to about three hundred nanometers and water, wherein the pH of the fluid is between 6 and 8.

In some embodiments, the fluid further comprises one or more surfactants.

In some embodiments, the amorphous silicas comprise colloidal silicas. The colloidal silicas may have a particle size which ranges from about three nanometers to about nine nanometers.

Some embodiments of the invention are directed to a method for facilitating hydraulic fracturing, comprising the step of discharging a fluid at the subterranean point of contact between the drill bit and the drilling surface, wherein the fluid includes amorphous silicas having a particle size ranging from about one to about three hundred nanometers and water, and wherein the pH of the fluid is between 6 and 8.

In some embodiments, the fluid of the aforementioned method further comprises one or more surfactants, the amorphous silicas may comprise colloidal silicas, and may have a particle size which ranges from about three nanometers to about nine nanometers.

Some embodiments of the invention are directed to a fluid for subterranean discharge in a borehole during a hydraulic fracturing process comprising colloidal silicas having a particle size ranging from about one to about three hundred nanometers, water, and an aluminum compound, wherein the pH of the fluid is between 6 and 8. The colloidal silicas may in some embodiments have a particle size which ranges from about three nanometers to about nine nanometers. In some embodiments, the colloidal silicas are catalyzed and expand upon contact with alkaline materials within the borehole.

### DETAILED DESCRIPTION OF THE INVENTION

The invention is directed to a solution including a substantially neutral pH solution containing amorphous silicas, which may be colloidal silicas, for use in drilling as a drilling fluid, and in particular, as a fluid for facilitating hydraulic fracturing. In some embodiments, the amorphous silicas, which may be colloidal silicas, have a particle size which ranges from about 1 to about 300 nanometers. In other embodiments, the amorphous silicas, which may be colloidal silicas, have a particle size which ranges from about 1 nanometers to about 150 nanometers, and in other embodiments, from about 3 nanometers to about 9 nanometers. In some embodiments, the aforementioned solution further includes one or more surfactants, while other ingredients may include water.

Some examples of surfactants include: anionic: Sodium linear alkylbenzene sulphonate (LABS); sodium lauryl sulphate; sodium lauryl ether sulphates; petroleum sulphonates; linosulphonates; naphthalene sulphonates, branched alkylbenzene sulphonates; linear alkylbenzene sulphonates; alcohol sulphates; cationic: Stearalkonium chloride; benzalkonium chloride; quaternary ammonium compounds; amine compounds; non-ionic: dodecyl dimethylamine oxide; coco diethanol-amide alcohol ethoxylates; linear primary alcohol polyethoxylate; alkylphenol ethoxylates; alcohol ethoxylates; EO/PO polyol block polymers; polyethylene glycol esters; fatty acid alkanolamides; amphoteric: Cocoamphocarboxyglycinate; cocamidopropylbetaine; betaines; imidazolines In addition to those listed above, suitable nonionic surfactants include alkanolamides, amine oxides, block polymers, ethoxylated primary and secondary alcohols, ethoxylated alkylphenols, ethoxylated fatty esters, sorbitan derivatives, glycerol esters, propoxylated and ethoxylated fatty acids, alcohols, and alkyl phenols, alkyl glucoside glycol esters, polymeric polysaccharides, sulfates and sulfonates of ethoxylated alkylphenols, and polymeric surfactants. Suitable anionic surfactants include ethoxylated amines and/or amides, sulfosuccinates and derivatives, sulfates of ethoxylated alcohols, sulfates of alcohols, sulfonates and sulfonic acid derivatives, phosphate esters, and polymeric surfactants. Suitable amphoteric surfactants include betaine derivatives. Suitable cationic surfactants include amine surfactants. Those skilled in the art will recognize that other and further surfactants are potentially useful in the compositions disclosed herein.

It has been advantageously discovered that the amorphous silica acts as an abrasive enabling the drilling fluid to facilitate drilling as a cutting compound, a flocculent as well as a lubricant. The viscosity of the overall fluid can be adjusted and managed with water.

It has been further advantageously discovered that the material removed from the borehole during the drilling process, such as rock or other matter having a high pH or alkalinity, when mixed with the amorphous silica of the fluid solution of the invention cause the amorphous silica to expand or “grow” during use. The growth of the catalyzed amorphous silica and expansive characteristic facilitates the drilling process, and in hydraulic fracturing particularly, by acting as a proppant, among other things. The fluid of the invention may include additional proppants, such as sand. Injecting the compound as a fluid medium into the borehole during the drilling process at or adjacent to the point of contact between a drill or other tooling and ground accelerates the removal of stock, rock and dirt, and therefore also extends the life of the tooling. The surface of borehole may include any material, such as naturally occurring materials in the ground.

The borehole may be flushed with the medium and/or water to flush cuttings away from the drill which is then forced up through the drilled hole around the outside of the drill and is piped away from the borehole.

In some embodiments, the size of silica used in the compound is adjusted either increased or decreased to, among other things, control the size reduction of cut particles during the drilling process to substantially match the size of the silica. The compound may also include as much as 5% silica sand.

An embodiment of a composition according to the present invention includes colloidal silica particles that are suspended in a water-based, or aqueous, solution. A stabilizer, which prevents aggregation of the silica particles and their precipitation from solution, may be present on portions of the surfaces of the silica particles. The stabilizer may comprise an aluminum compound, such as aluminum or aluminum oxide. In addition the water, the silica particles, and the stabilizer, the hardening composition may, in some embodiments, include a surfactant, which also facilitates suspension of the silica particles in the water. The silica particles remain suspended in the composition at a relatively low, substantially neutral (e.g., pH=6 to 8) or acidic pH. As an example the silica particles may remain in solution at a pH of as low as about 3 or about 3 ½ and as high as about 10 or about 10 ½. In a more specific example, the pH of a hardening composition of the present invention may be about 4 to about 7. In an even more specific example, a hardening composition that incorporates teachings of the present invention may have a pH of about 3 ½ to about 7.

In various embodiments, the silica particles and stabilizer of a composition of the invention may be provided as a colloidal silica suspension that includes silica particles having nominal sizes (e.g., diameters) of from about 3 nm to about 50 nm with an aluminum-based stabilizer.

In one embodiment of an application method according to the present invention, the composition is applied within a borehole before or during the drilling process. Once a composition according to the invention has been applied to a surface, the residue of the composition and cuttings may be removed, or cleaned, from the treated surface.

Some embodiments are directed to apparatus which include nozzles or discharge points for disposing a solution including colloidal silicas into a borehole during drilling operations which effectively reduces the particle size of concrete particles on the surface portion to about the size of the colloidal silicas.

Drilling fluids of the invention may be incorporated in any drilling systems and devices, such as the systems and devices disclosed in the following patents, which are incorporated herein by reference in their entireties to assist in providing enabling disclosure for the use of the drilling fluid of the invention in such various systems, according to the methods and technologies disclosed therein.

U.S. Pat. No. 4,098,363 discloses a design of a bit where the nozzles are positioned in the junk slots in the face of the bit with their axes oriented and so distributed across the face of the bit that the ejected streams of drilling fluid wash over the cutters and cover substantially the entire surface of the formation being cut by the bit when the bit is rotated. The longitudinal arrays of cutters therein are separated by the junk slots which also serve as water courses. The arrays of nozzles within the drill bit fluid channels produce a fluid flow of such velocity that bit cleaning and detritus removal is facilitated.

U.S. Pat. No. 4,471,845 discloses a device wherein the outlet cones of nozzles have been so dimensioned that all the cutting elements on a drill bit have been supplied with flushing fluid flow. Furthermore, the alignment of the nozzles has been varied depending on which direction of the flushing stream is desired with regard to optimum cutting bit cooling and cutting removal action. As further disclosed in U.S. Pat. No. 4,471,845, certain nozzles have been aligned so that they impress a direction tangential to the drill bit towards the cutting elements on the flushing stream, whereas other nozzles have been aligned to impress a radial component towards the marginal region of the bit on the flushing stream.

U.S. Pat. No. 4,452,324 discloses fluid nozzles in a drill bit which have been variously curved and thereby their flow directed towards the cutting members. This alignment gives the jets of the flushing fluid emerging from the curved nozzles an alignment with at least one component facing in the direction of the drillings flowing off along the outer face of the body.

Drill bits have also been designed with a multiplicity of individual diamond insert studs which include an axially aligned fluid passage formed within the insert stud which communicates with a fluid-filled chamber formed by the drag bit. The fluid exits the passage in the stud in front of the diamond cutting face of the stud to assure cooling and cleaning of each insert stud inserted in the face of the drag bit. One such design is disclosed in U.S. Pat. No. 4,303,136.

U.S. Pat. No. 4,606,418 discloses a design in which the discharge nozzle is actually placed within the cutting face itself and directs drilling fluid away from the cutting face and into the formation to be cut.

U.S. Pat. No. 4,852,671 discloses a design in which the cutting disc edge and the leading end of the stud the disc is mounted on include a channel meant to conduct cooling fluid to the cutting points to clean and cool the same.

U.S. Pat. No. 4,883,132 discloses a design in which the hydraulic nozzles are defined in the bit body beneath and azimuthally behind the arches formed by each blade. The nozzles direct hydraulic flow across the cavity under the arch and across each portion of the cutting face on the arch. As a result, when cutting, substantially only a diamond surface is provided for shearing a rock formation or contacting with velocity any portion of the plastic rock formation. Once the rock chip is extruded upwardly across the diamond face of the cutter, it is subjected to a directed hydraulic flow which peels the chip from the diamond face and transports it into the open cavity designed underneath the arch blade.

U.S. Pat. No. 4,913,244 discloses a design with improved rotating drag bit for cutting plastic, sticky, water reactive, and shell formations wherein each large cutter is provided with at least one hydraulic nozzle which in turn provides a directed hydraulic flow at the corresponding cutter face. The directed hydraulic flow is positioned to apply a force to the chip which tends to peel the chip away from the cutter face. In addition, the hydraulic flow is positioned with respect to the chip so as to apply an off-center torque to the chip which is used to peel the chip away from the cutter face and toward the gauge of the bit.

In most hydraulic bit designs, the fluid stream with the drilling fluid of the invention would be directed at the flat face of a cutter. Upon hitting this face, the drilling fluid flow spreads out over the surface.

It will be appreciated by those skilled in the art that while the invention has been described above in connection with particular embodiments and examples, the invention is not necessarily so limited, and that numerous other embodiments, examples, uses, modifications and departures from such embodiments, examples and uses are all intended to be encompassed by the spirit and scope of the invention as described herein, as would be understood to one of ordinary skill in the art, and set forth by the claims.

1. A drilling fluid for discharging adjacent a drill bit during subterranean drilling in a borehole, the fluid comprising amorphous silicas having a particle size ranging from about one to about three hundred nanometers and water, wherein the pH of the fluid is between 6 and 8.

2. A drilling fluid solution as recited in claim 1, wherein the fluid further comprises one or more surfactants.

3. A drilling fluid solution as recited in claim 1, wherein the amorphous silicas comprise colloidal silicas.

4. A drilling fluid solution as recited in claim 3, wherein the colloidal silicas have a particle size which ranges from about three nanometers to about nine nanometers.

5. A method for facilitating hydraulic fracturing, comprising the step of discharging a fluid at the subterranean point of contact between the drill bit and the drilling surface, wherein the fluid includes amorphous silicas having a particle size ranging from about one to about three hundred nanometers and water, and wherein the pH of the fluid is between 6 and 8.

6. A method according to claim 5, wherein the fluid further comprises one or more surfactants.

7. A method according to claim 5, wherein the amorphous silicas comprise colloidal silicas

8. A method according to claim 7, wherein the colloidal silicas have a particle size which ranges from about three nanometers to about nine nanometers.

9. A fluid for subterranean discharge in a borehole during a hydraulic fracturing process comprising colloidal silicas having a particle size ranging from about one to about three hundred nanometers, water, and an aluminum compound, wherein the pH of the fluid is between 6 and 8.

10. A fluid as recited in claim 9, wherein the colloidal silicas have a particle size which ranges from about three nanometers to about nine nanometers.

11. A fluid as recited in claim 9, wherein the colloidal silicas are catalyzed and expand upon contact with alkaline materials within the borehole.
